(19) United States
(12) Patent Application Publication
(10) Pub. No.: US 2003/0214756 A1
(43) Pub. Date: Nov. 20, 2003

(54) Flying head slider and information recording and/or reproduction apparatus

(75) Inventors: Kazuyuki Yamamoto, Kanagawa (JP); Michio Yotsuya, Kanagawa (JP); Koji Fukumoto, Kanagawa (JP); Kazushige Kawazoe, Kanagawa (JP); Toshio Mamiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/407,431

(22) Filed: Apr. 7, 2003

(30) Foreign Application Priority Data
Apr. 10, 2002 (JP) 2002-108007

(51) Int. Cl. G11B 5/60

(52) U.S. Cl. 360/236.3; 360/235.8

(57) ABSTRACT

A flying head slider is disclosed which can fly stably above the surface of a recording medium and thereby prevent deterioration of a reproduction signal output of the head. The flying head slider has a head for recording and reproducing information onto and from a recording medium and has an air bearing portion at an opposing portion thereof which opposes to the recording medium. The flying head slider is acted upon by buoyancy by air bearing caused by dynamic pressure between the air bearing portion and a surface of the recording medium. The flying head slider is disposed with respect to the recording medium such that, within a flying region of the flying head slider in a radial direction of the information recording medium between an inner circumference position and an outer circumference position of the surface of the recording medium, a flying pitch angle equal to or greater than 120 μrad is formed between the air bearing portion and the surface of the recording medium.

### BACKGROUND OF THE INVENTION

This invention relates to a flying head slider on which a head is carried and an information recording and/or reproduction apparatus which includes a flying head slider.

A hard disk drive (HDD) apparatus as a kind of information recording and/or reproduction apparatus is built in or can be externally connected to an electronic apparatus which can record and reproduce information such as, for example, a portable computer.

Part of a hard disk drive apparatus of the type is shown in FIG. 13. Referring to FIG. 13, a flying head slider 1004 is flown by air bearing above a surface 1003 of a magnetic disk 1002, which is a kind of disk-type recording medium. A magnetic head 1005 of the flying head slider 1004 records or reproduces information onto or from the magnetic disk 1002. Buoyancy is generated by air bearing by dynamic pressure between an air-bearing portion 1006 of the flying head slider 1004 and the surface 1003 of the magnetic disk 1002 to cause the flying head slider 1004 to fly.

FIGS. 14A and 14B show a shape of the air bearing portion 1006 of the slider 1004 shown in FIG. 13. Referring to FIGS. 14A and 14B, the air bearing portion 1006 has a positive pressure generation portion 1010, a step 1011, and a deep groove 1013. By an action of an airflow generated upon rotation of the magnetic disk 1002 shown in FIG. 13, the positive pressure generation portion 1010 generates the positive pressure while negative pressure is generated at a negative pressure generation portion 1014 provided in the deep groove 1013. The slider 1004 is supported by a suspension 1020 shown in FIG. 13, and the suspension 1020 presses the slider 1004. The flying head slider 1004 can fly stably above the disk 1002 at a balanced point among the load when the flying head slider 1004 is pressed by the suspension 1020 and the positive and negative pressures mentioned above.

Referring back to FIG. 13, the slider 1004 is frequently designed such that it has a comparatively great flying pitch angle E of approximately 50 μrad to 100 μrad within a region in a radial direction of the magnetic disk 1002 used. The flying pitch angle E decreases toward the inner circumference side of the magnetic disk 1002 while it increases toward the outer circumference side of the magnetic disk 1002. The reason is that, since the magnetic disk 1002 rotates at a constant angular velocity (CAV), the circumferential speed is lower on the inner circumference side of the magnetic disk 1002 but is higher on the outer circumference side of the magnetic disk 1002.

Incidentally, in recent years, in order to achieve higher density recording of a magnetic disk apparatus, decrease of the floating amount of the slider is proceeding. However, if the minimum floating amount of the slider decreases until the slider comes proximately to the glide height of the disk (in the case of so-called a near-contact system), the slider frequently contacts with the surface of the magnetic disk. From this reason, the conventional magnetic disk apparatus has a problem in that (1) it is difficult to cause the slider to fly stably. On the other hand, a removable disk apparatus has another problem in that, since the slider and the disk sometimes contact with each other through dust, (2) it is difficult to cause the slider to fly stably.

The problems (1) and (2) described above give rise to another problem particularly in vibration of the suspension or a drop of a reproduction signal output of the magnetic head.

### SUMMARY OF THE INVENTION

It is an object of the present invention to provide a flying head slider, which can fly stably above the surface of a recording medium and thereby prevent deterioration of a reproduction signal output of the head.

It is another object of the present invention to provide an information recording and/or reproduction apparatus including a said flying head slider.

In order to attain the objects described above, according to an aspect of the present invention, there is provided a flying head slider having a head for recording and reproducing information onto and from a recording medium, the flying head slider having an air bearing portion at an opposing portion thereof which opposes to the recording medium, the flying head slider being acted upon by buoyancy by air bearing caused by dynamic pressure between the air bearing portion and a surface of the recording medium, the flying head slider being disposed with respect to the recording medium such that, within a flying region of the flying head slider in a radial direction of the information recording medium between an inner circumference position and an outer circumference position of the surface of the recording medium, a flying pitch angle equal to or greater than 120 μrad is formed between the air bearing portion and the surface of the recording medium.

According to another aspect of the present invention, there is provided an information recording and/or reproduction apparatus, including a head for recording and reproducing information onto and from a recording medium, and a flying head slider carrying the head thereon, the flying head slider having an air bearing portion at an opposing portion thereof which opposes to the recording medium, the flying head slider being acted upon by buoyancy by air bearing caused by dynamic pressure between the air bearing portion and a surface of the recording medium, the flying head slider being disposed in relationship to the recording medium such that, within a flying region of the flying head slider in a radial direction of the information recording medium between an inner circumference position and an outer circumference position of the surface of the recording medium, a flying pitch angle equal to or greater than 120 μrad is formed between the air bearing portion and the surface of the recording medium.

In both of the flying head slider and the information recording and/or reproduction apparatus, within the flying region of the flying head slider in a radial direction of the information recording medium between an inner circumference position and an outer circumference position of the surface of the recording medium, the flying pitch angle formed between the air bearing portion and the surface of the recording medium is equal to or greater than 120 μrad.

Where the flying pitch angle is equal to or greater than 120 μrad in this manner, even in a system wherein the slider and the surface of the recording medium frequently contact with each other and the minimum floating amount of the slider is small, that is, even if the slider flies low, the slider can fly stably upon less contact possibility. Further, even in an environment wherein excessive amount of dust is present in the proximity of the recording medium and the flying head slider, where the flying pitch angle is equal to or greater than 120 μrad, the variation of the floating amount is small without being influenced by the dust.

Preferably, in both of the flying head slider and the information recording and/or reproduction apparatus, the minimum value of the minimum floating amount when an air flowing out end of the air bearing portion flies above the surface of the recording medium is 17 nm or less.

Here, in the case where the floating amount is higher than 17 nm, no special technical problem does not arise, but rather, a system wherein the flying head slider and the surface of the recording medium does not contact with each other can be constructed. Therefore, there is no necessity to stick to the pitch. If the floating amount is decreased in order to raise the recording density, then it becomes necessary to consider the contact possibility, and the threshold level therefor is 17 to 12 nm although it depends upon conditions.

Thus, where the minimum value of the minimum floating amount is higher than 17 nm, the spacing loss makes the head to record information onto the recording medium or deteriorates the performance of the head in reproduction of information from the recording medium.

In order to improve the recording density, it is most significant to decrease the spacing loss, that is, to decrease the floating amount. However, the decrease of the floating amount give rise the problems described below. Incidentally, the glide height of a medium used is approximately 12 nm. Here, it is possible to design and manufacture a system and the minimum value of the minimum floating amount is higher than 17 nm and thereby the glide height of the medium is not reached even if the existence of various floating amount decreasing factors are taken into consideration, i.e., the contact does not need be taken into consideration.

In a system wherein the minimum value of the minimum floating amount is equal to or smaller than 17 nm, the minimum floating amount reaches the glide height due to a dispersion in flying of individual sliders, for example, a decrease of the floating amount in a reduced pressure environment at a height of 5,000 m or a decrease of the floating amount by a seek operation (5 nm total). Therefore, depending upon the object of use of the flying head slider, a system wherein the contact is taken into consideration must be taken into consideration.

Further, in a system wherein the minimum value of the minimum floating amount is equal to or lower than 14 nm, since the minimum floating amount reaches the glide height even with a floating dispersion (2 nm) of individual sliders, a system wherein the contact is taken into consideration must be taken into consideration additionally with the dispersion taken into consideration. Further, in a system wherein the minimum value of the minimum floating amount is equal to or lower than 12 nm, a system wherein the contact is most valued must be taken into consideration.

Preferably, in both of the flying head slider and the information recording and/or reproduction apparatus, the flying pitch angle ranges from 120 μrad to 240 μrad both inclusive.

Where the flying pitch angle is smaller than 120 μrad, and the slider flies low, high contact force is applied from the slider to the surface of the recording medium, which disturbs stable flying of the slider.

On the other hand, where the flying pitch angle is greater than 240 μrad, the gap floating amount (GapFH) becomes substantially equal to the minimum floating amount (minFH)+2 nm, and the merit in lowered flying is lost.

In both of the flying head slider and the information recording and/or reproduction apparatus, the air bearing portion may have a first air bearing surface formed adjacent to the opposing portion for generating positive pressure, a second air bearing surface formed at a position deeper than the first air bearing surface, and a third air bearing surface formed at a position deeper than the second air bearing surface. The first air bearing surface may include an air flowing in end side positive pressure generation surface formed adjacent to an air flowing in end of the air bearing portion with a full width in a widthwise direction of the flying head slider and an air flowing out end side positive pressure generation surface formed adjacent to the air flowing out end of the air baring portion and including the head.

Where the air flowing in end side positive pressure generation surface of the first air bearing surface is formed with a full width in a widthwise direction of the flying head slider in this manner, the air flowing in end side (leading side) positive pressure generation surface can be formed with a great area, and the flying pitch angle can be set equal to or greater than 120 μrad easily. The head performs recording and reproduction of a signal onto and from the recording medium.

In the information recording and/or reproduction apparatus, the recording medium may be a removable disk.

Where the recording medium is a removable disk, the information recording and/or reproduction apparatus is a removable disk drive apparatus. Thus, even in the removable disk drive apparatus, even if the slider flies low, the contacting force of the slider with the surface of the recording medium is low, and the slider can fly stably.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a perspective view showing an example of an information recording and/or reproduction apparatus, which includes a flying head slider according to the present invention;

FIG. 2 is a schematic view showing the slider shown in FIG. 1 and a magnetic disk;

FIG. 3 is a perspective view showing a flying head slider to which the present invention is applied;

FIG. 4 is a plan view showing the flying head slider of FIG. 3;

FIG. 5 is a schematic diagrammatic view showing a flying pitch angle formed between the flying head slider of the present invention and a magnetic disk;

FIG. 6A is a schematic diagrammatic view showing the slider and a suspension and FIG. 6B is a diagrammatic view showing an example of a flying pitch angle θ of the slider of FIG. 2;

FIGS. 7A and 7B are diagrammatic views illustrating a relationship between the flying state of the slider and SWAY vibration of the suspension;

FIG. 8 is a diagrammatic view illustrating a relationship between the flying pitch angle of the slider and an output of the head under condition of that dust sticks to the disk;

FIG. 9 is diagrammatic view illustrating the flying pitch angle of the slider of FIG. 2;

FIGS. 10A and 10B are a perspective view and a plan view, respectively, of a first modification to the flying head slider shown in FIGS. 3 and 4;

FIGS. 11A and 11B are a perspective view and a plan view, respectively, of a second modification to the flying head slider shown in FIGS. 3 and 4;

FIG. 12 is an exploded schematic perspective view showing another information recording and/or reproduction apparatus to which the present invention is applied;

FIG. 13 is a schematic view illustrating a relationship between a genera slider and a magnetic disk of a conventional information recording and/or reproduction apparatus; and

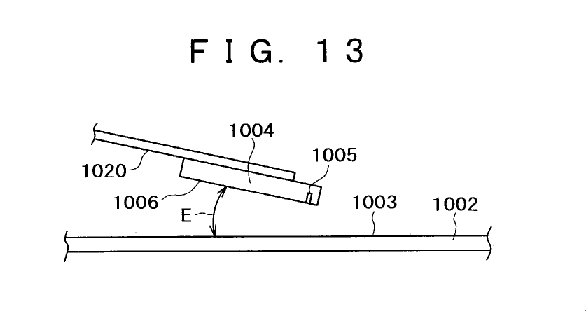

FIGS. 14A and 14B are a perspective view and a plan view, respectively, of the slider of FIG. 13.

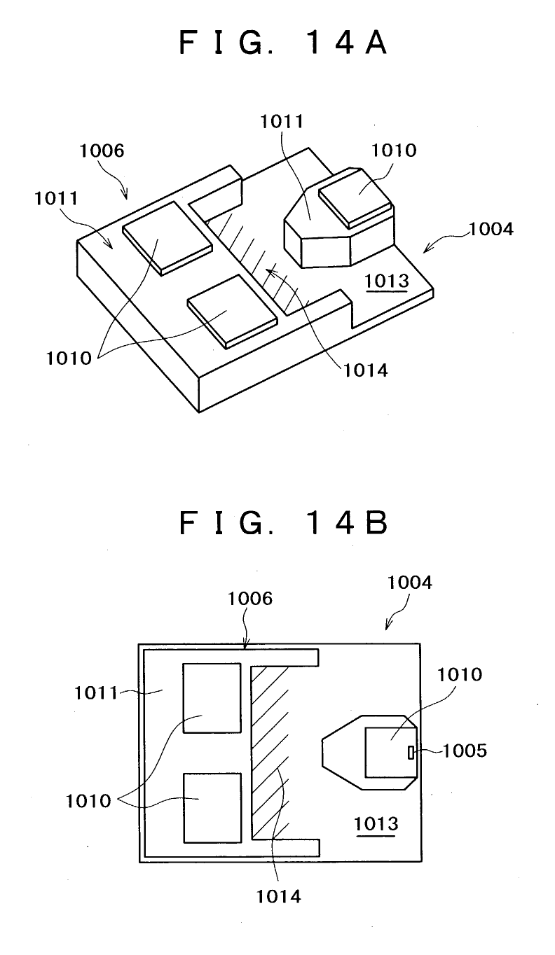

### DESCRIPTION OF THE PREFERRED EMBODIMENT

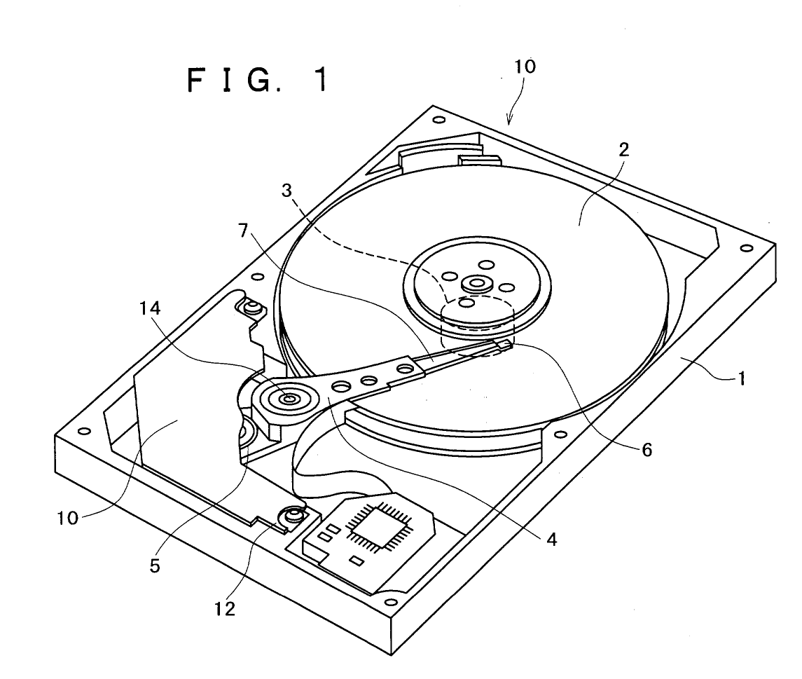

Referring to FIG. 1, there is shown an information recording and/or reproduction apparatus to which the present invention is applied and which includes a flying head slider to which the present invention is applied.

The information recording and/or reproduction apparatus shown is formed as a hard disk drive apparatus (HDD) The hard disk drive apparatus 10 is a kind of magnetic recording and reproduction apparatus and includes a housing 1 and a magnetic disk 2 accommodated in the housing 1. The magnetic disk 2 is a kind of disk called hard disk (HD). The magnetic disk 2 is driven to rotate at a constant angular velocity by a spindle motor 3.

A voice coil 5 is attached to an end of an arm 4. A suspension 7 is attached to the other end of the arm 4. A flying head slider (hereinafter referred to simply as slider) 6 is attached to a tip end of the suspension 7.

The voice coil 5 is disposed at a position between a magnet 13 and another magnet 12, and the voice coil 5 and the magnets 13 and 12 cooperatively form a voice coil motor. Current flowing through the voice coil 5 is acted upon by force from a magnetic field generated by the magnets 13 and 12 to pivot the arm 4 around a shaft 14.

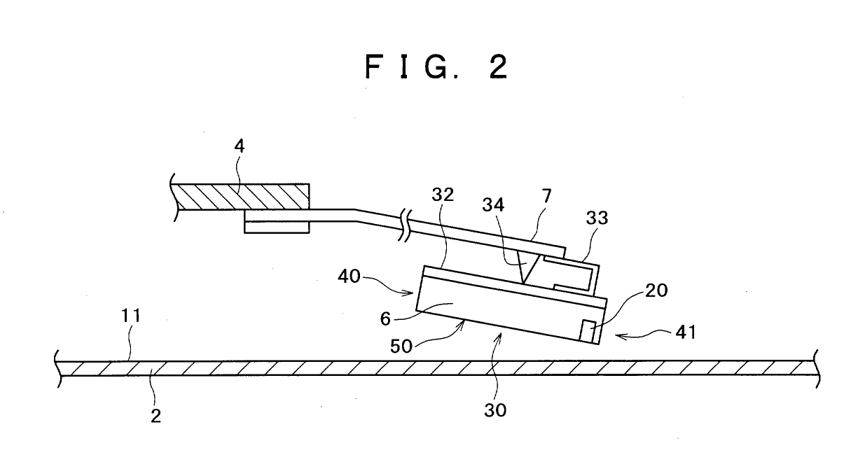

Consequently, a magnetic head 20 shown in FIG. 2 attached to the slider 6 moves in a radial direction, that is, a seek direction with respect to a surface 11 of the magnetic disk 2 to magnetically record information onto a predetermined track on the surface 11 of the magnetic disk 2 or magnetically reproduce information recorded on the magnetic disk 2.

The slider 6 shown in FIG. 2 typically has a shape of a rectangular parallelepiped and has an opposing portion 30 and a front surface portion 32. The opposing portion 30 is a portion opposing to the surface 11 of the magnetic disk 2. The magnetic disk 2 is a kind of recording medium.

The front surface portion 32 is attached to an end portion of the suspension 7 using, in the arrangement shown in FIG. 2, a gimbal 33. The suspension 7 supports the front surface portion 32 of the slider 6 using a pivot 34. The other end portion of the suspension 7 is secured to the arm 4.

The slider 6 has an air flowing (leading) end 40 and an air flowing out (trailing) end 41. The air flowing in end 40 is also called air flowing in portion or air introduction portion or the like, and the air flowing out end 41 is also called air flowing out portion or the like.

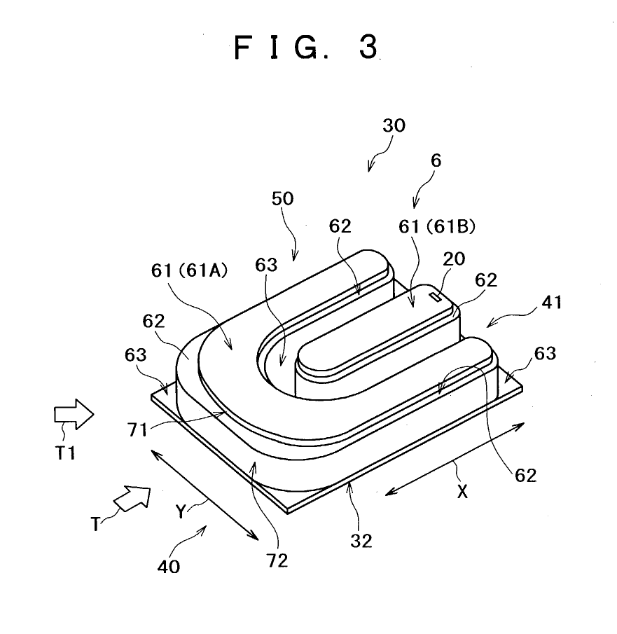

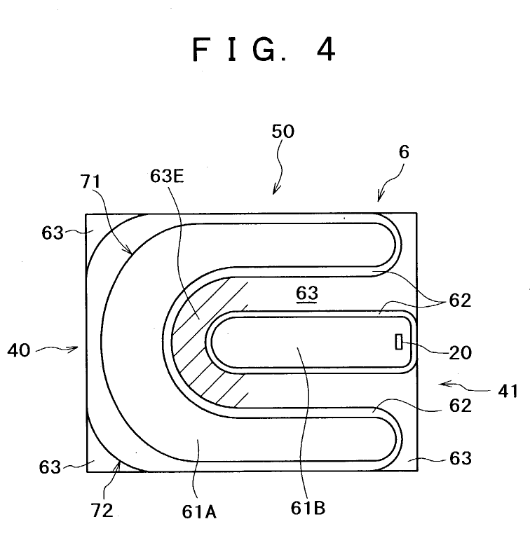

FIGS. 3 and 4 show a preferred configuration of the slider 6 of FIG. 2. In FIGS. 3 and 4, the shape of the slider 6 on the opposing portion 30 side is shown particularly.

The configuration of the air bearing portion of the slider in the embodiment of the present invention and modifications to the same described below can be formed, for example, using physical dry etching.

Referring to FIGS. 3 and 4, an air bearing portion (also referred to as air bearing face formation portion) 50 formed on the opposing portion 30 side of the slider 6 is a portion counter side of the front surface portion 32. An air bearing action by dynamic pressure is produced between the air bearing portion 50 and the surface 11 of the magnetic disk 2 shown in FIG. 2, whereupon the slider 6 is acted upon by buoyancy with respect to the surface 11 to secure a predetermined floating amount between the magnetic head 20 and the surface 11 of the magnetic disk 2.

The air bearing portion 50 for generating the air bearing action has a layer structure, for example, of three stages by such physical dry etching as mentioned hereinabove over a range from the air bearing portion 50 to the air flowing out end 41. In the layer structure of three stages, the air bearing portion 50 has a first air bearing surface 61 (61A and 61B), a second air bearing surface 62 and a third air bearing surface 63. The layer structure may otherwise have four or more stages.

As seen in FIGS. 3 and 4, the first air bearing surface 61 has an air flowing in end side positive pressure generation surface 61A and an air flowing out end side positive pressure generation surface 61B. The air flowing in end side positive pressure generation surface 61A is formed over a substantially overall range of the air bearing portion 50 in a Y direction, which is a widthwise direction of the slider 6, on the air flowing in end 40 side. In this manner, the positive pressure generation surface 61A on the air flowing in end 40 side can be formed with a great area, and in the arrangement shown in FIGS. 3 and 4, the positive pressure generation surface 61A generally has a substantially U-shape. Where the positive pressure generation surface 61A is formed with a great area in this manner, a great floating pitch angle of 120 μrad or more can be secured readily as the floating pitch angle of the slider 6 which is hereinafter described. In this manner, the positive pressure generation surface 61A is formed such that it extends over the overall width or over the substantially overall width in the Y direction, that is, in the widthwise direction of the slider 6.

The positive pressure generation surface 61B on the air flowing out end 41 side shown in FIGS. 3 and 4 has, for example, an I-shape and is formed between and along the straight portions of the U-shape of the positive pressure generation surface 61A. The positive pressure generation surface 61B is also called rear rail. The head 20 is provided on the positive pressure generation surface 61B adjacent to the air flowing out end 41. Where the magnetic head 20 is provided at an end portion of the positive pressure generation surface 61B adjacent to the air flowing out end 41, when the slider 6 is flying in FIG. 2, a necessary floating amount between the magnetic head 20 and the surface 11 of the magnetic disk 2 can be secured sufficiently. The positive pressure generation surface 61A and the positive pressure generation surface 61B are formed to extend in parallel to each other along an X direction, that is, a direction perpendicular to the Y direction.

The second air bearing surface 62 shown in FIGS. 3 and 4 is formed at a deeper position than the first air bearing surface 61 toward the front surface portion 32 side. The second air bearing surface 62 is formed with a first offset portion 71 with respect to the first air bearing surface 61. The second air bearing surface 62 is also called step or shallow groove.

The third air bearing surface 63 is formed at a further deeper position than the second air bearing surface 62 toward the front surface portion 32. The third air bearing surface 63 is formed with a second offset portion 72 with respect to the second offset portion 72. The third air bearing surface 63 is also called deep groove. A portion of the third air bearing surface 63 which is positioned between the positive pressure generation surface 61A and the positive pressure generation surface 61B forms a negative pressure generation portion 63E. The negative pressure generation portion 63E is indicated by slanting lines in FIG. 4 and generates negative pressure.

Consequently, the slider 6 is pressed toward the surface 11 side of the magnetic disk 2 in FIG. 2 by the suspension 7, and the slider 6 can stably fly with respect to the surface 11 at a balanced point among the load by the slider 6 by the suspension 7 and the positive and negative pressures described above.

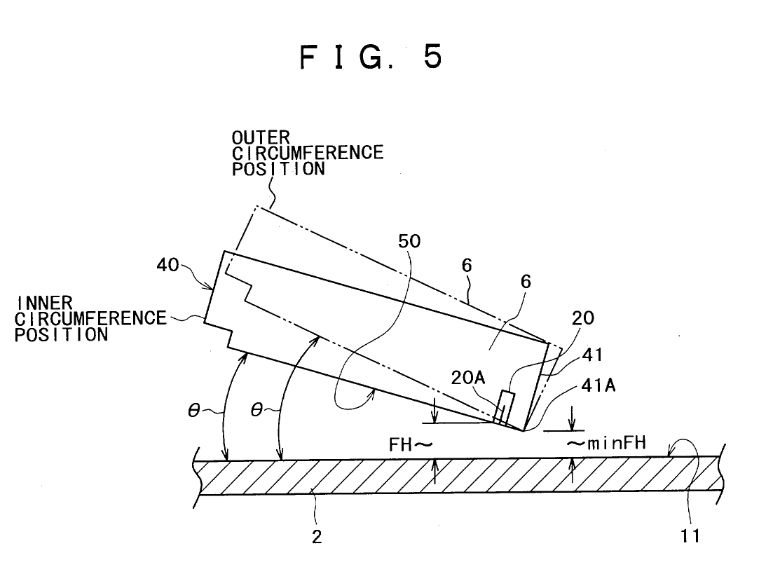

FIG. 5 illustrates a positional relationship between the slider 6 and the magnetic disk 2 described above. The air bearing portion 50 of the slider 6 and the surface 11 of the magnetic disk 2 define a flying pitch angle θ therebetween.

The flying pitch angle θ is formed between the air bearing portion 50 and the surface 11 such that the slider 6 is inclined such that the air flowing in end 40 side thereof is positioned higher than the air flowing out end 41 side with respect to the magnetic disk 2.

The slider 6 indicated by solid lines in FIG. 5 indicates an example of the angle when the slider 6 is positioned at an inner circumference position of the magnetic disk 2 while the slider 6 indicated by alternate long and chain double-dashed line in FIG. 5 indicates an example of the angle when the slider 6 is positioned at an outer circumference position of the magnetic disk 2.

Accordingly, as the slider 6 moves from the inner circumference position to the outer circumference position, the flying pitch angle θ of the slider 6 increases.

In FIG. 5, the minimum floating amount between the surface 11 of the magnetic disk 2 and a lower end 41A of the air flowing out end 41 is indicated by minFH. Meanwhile, the distance between a gap 20A of the magnetic head 20 and the surface 11 is indicated as Gap FH.

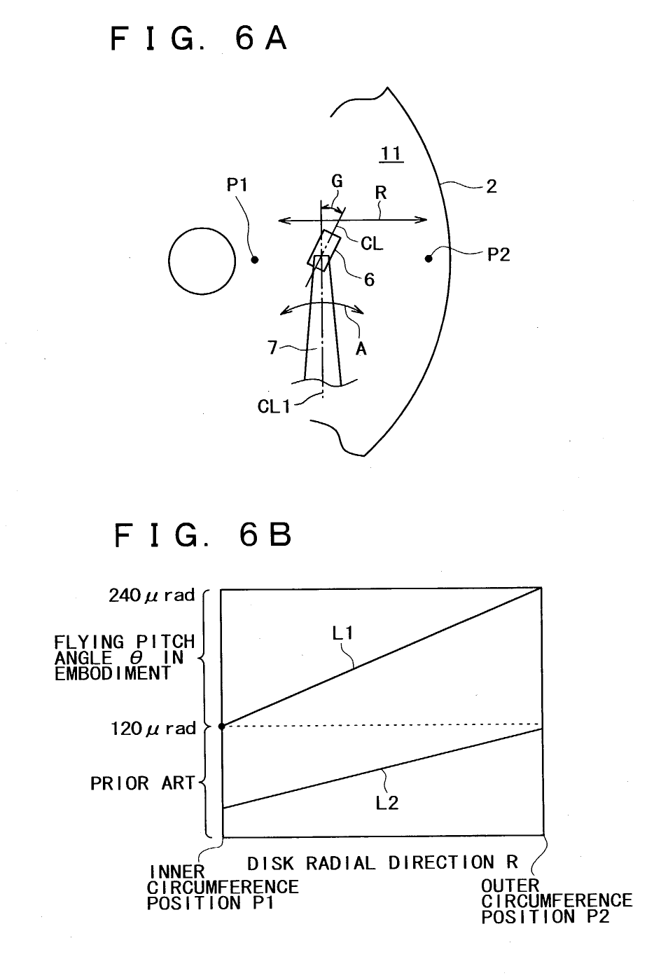

The flying pitch angle θ shown in FIG. 5 is an angle defined between the air bearing portion 50 and the surface 11 of the magnetic disk 2 in FIG. 5 within a floating region with regard to a radial direction R of the slider 6 between an inner circumference position P1 and an outer circumference position P2 of the magnetic disk 2 shown in FIG. 6A. The flying pitch angle θ is equal to or greater than 120 μrad.

Besides, the flying pitch angle θ preferably is equal to or greater than 120 μrad but equal to or smaller than 240 μrad.

Where the flying pitch angle θ is smaller than 120 μrad, if the slider 6 flies low, then particularly in the near-contact system wherein the slider 6 and the surface 11 contact frequently to each other, there is the possibility that a high contact pressure of the slider 6 may be applied to the surface 11.

On the other hand, where the flying pitch angle θ is greater than 240 μrad, the gap floating amount (GapFH) becomes the minimum floating amount (minFH)+approximately 2 nm, and there is a problem that the merit in low flying is lost.

Where the flying pitch angle θ is equal to or greater than 120 μrad, even if the slider 6 flies low, particularly in an apparatus of the near-contact system wherein the slider 6 and the surface 11 contact frequently to each other, the contact force of the slider 6 toward the surface 11 is low. Therefore, even if the slider 6 is in a near-contact state with the surface 11, the slider 6 can stably fly over the surface 11 of the magnetic disk 2.

Further, even if the surface 11 of the magnetic disk 2 and the slider 6 of FIG. 5 are placed in an environment wherein excessive amount of dust is present, where the flying pitch angle θ is equal to or greater than 120 μrad, the variation in flying is small. Accordingly, even with a removable hard disk drive apparatus which is a kind of removable disk drive apparatus hereinafter described wherein a magnetic disk can be removably mounted, the slider can fly stably.

In order to make the flying pitch angle θ equal to or greater than 120 μrad, simulation design is required essentially. Particularly by performing simulation design while the area principally of the positive pressure generation surface 61A also called front rail as shown in FIGS. 3 and 4 is adjusted suitably, a target flying pitch angle θ of the slider can be obtained.

It is to be noted here that the flying pitch angle θ relies upon the radius of the magnetic disk 2. In particular, at the inner circumference position P1 of the magnetic disk 2 shown in FIG. 6A, the flying pitch angle θ is as small as that of the slider 6 indicated by solid lines in FIG. 5, but the flying pitch angle θ increases toward the outer circumference position P2 shown in FIG. 6A like the slider 6 indicated by alternate long and chained double-dashed line in FIG. 5. To this end, it is necessary to design the flying pitch angle θ of the slider 6 shown in FIG. 5 so as to be equal to or greater than 120 μrad over the overall range of the flying region in the radial direction R of the magnetic disk 2 in FIG. 6. More particularly, the flying pitch angle θ at the inner circumference position P1 shown in FIG. 6A should be set equal to or greater than 120 μrad over the overall range of the levitation region.

FIG. 6B illustrates the range of the flying pitch angle θ of the flying head slider of the present embodiment, and a straight line L1 indicates an example of the angle variation of the flying pitch angle θ of the slider 6 of the present embodiment, which appears from the inner circumference position P1 to the outer circumference position P2. In contrast, with a conventional slider, the flying pitch angle θ is not greater than 120 μrad not only at the inner circumference position P1 but also at the outer circumference position P2 as indicated by another straight line L2 in FIG. 6B.

It is to be noted that, if the height of the positive pressure generation face of the slider 6 shown in FIG. 3 is defined to be zero, then the depth of the second air bearing surface 62 with respect to the first air bearing surface 61 is, for example, −0.4 μm, and the depth of the third air bearing surface 63 with respect to the first air bearing surface 61 is, for example, −2 μm.

Subsequently, functions and actions of the flying head slider of the present embodiment are described.

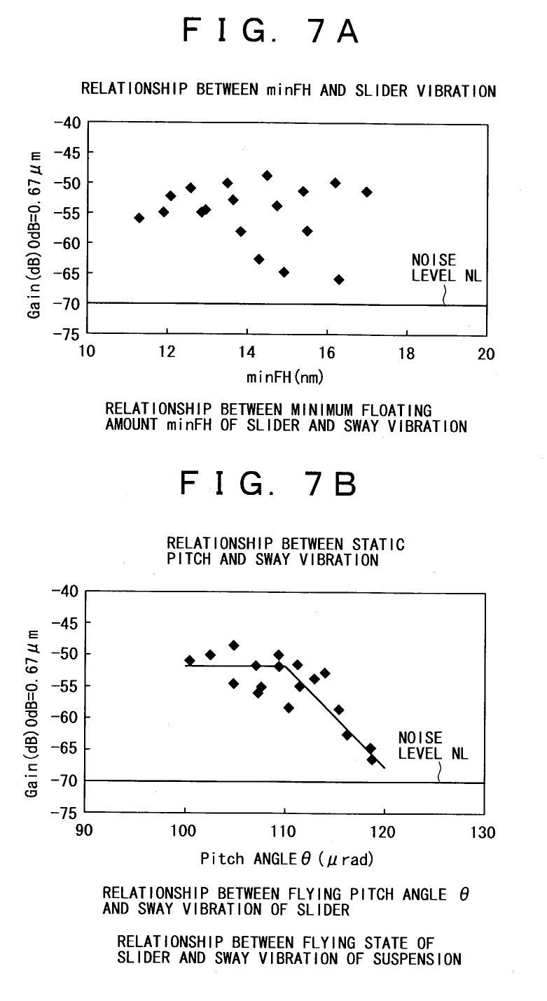

FIGS. 7A and 7B illustrate relationships between the flying state of the slider and SWAY vibration of the suspension. More particularly, FIG. 7A illustrates a relationship between the minimum floating amount minFH and SWAY vibration of the slider of the present embodiment, and FIG. 7B illustrates a relationship between the flying pitch angle θ of the slider and the SWAY vibration.

Various models of the slider of the present embodiment having different shapes were produced, and with the models, the SWAY vibration of the suspension was measured while the slider flied with the minimum floating amount minFH for the case of the glide height (for example, 11 nm here) of a magnetic disk+α (approximately 0 to 6 nm here: the maximum levitation amount was approximately 17 nm). Results of the measurement are illustrated in FIGS. 7A and 7B.

FIG. 7A illustrates a relationship between the minimum floating amount minFH of the slider and the peak gain of the SWAY vibration of the suspension, and FIG. 7B illustrates a relationship between the flying pitch angle θ of the slider and the peak gain of the SWAY vibration of the suspension.

The SWAY vibration is vibration of the suspension 7 when the suspension 7 performs a tracking movement in the direction indicated by A in FIG. 6A. The reason why the SWAY vibration is selected as an index here is that it has become clear through experiments that, where the contact force between the slider 6 and the surface 11 of the magnetic disk 2 is high, the contacting force is applied as exciting force to the suspension 7 through the slider 6 to excite the SWAY mode of the suspension 7.

By measurement of the SWAY vibration of the suspension 7, the contact force between the slider 6 and the surface 11 of the magnetic disk 2 can be observed indirectly.

Further, if SWAY vibration of a level higher than a certain level is generated in the drive apparatus, then this makes a cause of a tracking error of the magnetic head of the slider 6, and therefore, the evaluation through the SWAY vibration is high in reality. The SWAY vibration of the suspension first matters particularly with the near-contact system described hereinabove.

It was found that, in FIG. 7A, the relationship between the minimum floating amount minFH of the slider and the SWAY vibration exhibits no correlation, but in FIG. 7B, the relationship between the flying pitch angle θ of the slider and the SWAY vibration exhibits some correlation.

Although the results of the measurement in FIG. 7B were derived from the sliders wherein the flying pitch angle θ is smaller than 120 μrad, since the noise level NL is −70 dB. Thereby where the flying pitch angle θ of the slider of the present embodiment is equal to or greater than 120 μrad, the SWAY vibration is lower than the noise level NL, and this does not matter in actual use of the slider.

As seen from FIG. 7B, it has been found out that, without depending upon the type of the slider, where the flying pitch angle θ becomes smaller than 120 μrad, the mode in the SWAY oscillation begins to be excited, and where the flying pitch angle θ is smaller than 110 μrad, the mode is substantially saturated.

As a result, by setting the flying pitch angle θ equal to or greater than 120 μrad, the disturbance input by contact between the slider 6 and the surface 11 of the magnetic disk 2 can be minimized and particularly the problem of the SWAY vibration of the suspension has been solved successfully.

Consequently, where the flying pitch angle θ of the slider is equal to or greater than 120 μrad, in the near-contact system wherein the slider and the surface of the recording medium contact frequently to each other, when the minimum flying amount of the slider is small, that is, when the slider flies low, the slider stably flies with the reduced contacting force of the slider to the surface of the disk.

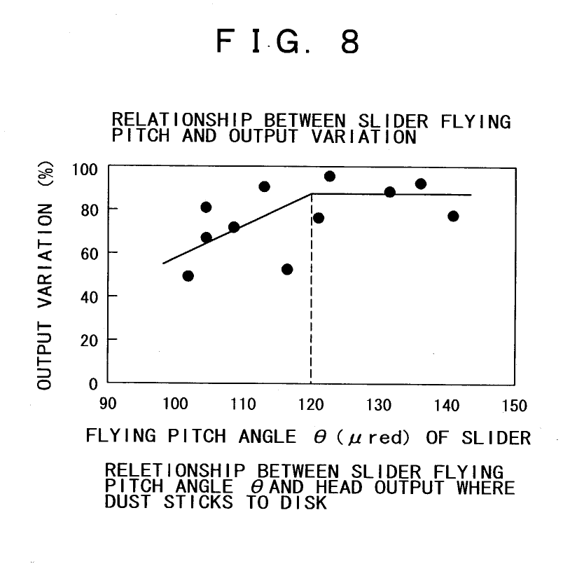

FIG. 8 illustrates results of the measurement of the reproduction signal output from the magnetic head while the various sliders flew above a magnetic disk to which dust was applied uniformly so that the area of the dust occupying in the surface area of the disk was set, for example, to 0.05%. The minimum floating amount minFH of the slider in FIG. 5 in this instance was approximately 20 nm.

Referring to FIG. 8, the axis of ordinate represents a dimensionless output variation determined by dividing the reproduction signal output of the magnetic head as measured with a clean magnetic disk by the reproduction signal output of the magnetic head as measured with the magnetic disk to which dust sticks. The output variation (%) of the axis of ordinate indicates that, as it approaches 100%, the drop of the reproduction signal output decreases and the reproduction signal output is better, but as it decreases, the reproduction signal output deteriorates.

From FIG. 8, it can be seen that, where the flying pitch angle θ of the slider is smaller than 120 μrad, the reproduction signal output deteriorates suddenly irrespective of the type of the slider. In other words, if the flying pitch angle θ of the slider is set equal to or greater than 120 μrad, then the flying variation by disturbance arising from contact between the slider 6 and the surface 11 of the magnetic disk 2 through dust can be minimized, and particularly the problem of the deterioration of the reproduction signal output from the magnetic head has been solved successfully. In other words, even in an environment in which much dust is involved, the variation of the levitation amount of the slider is minimized without being influenced by the dust.

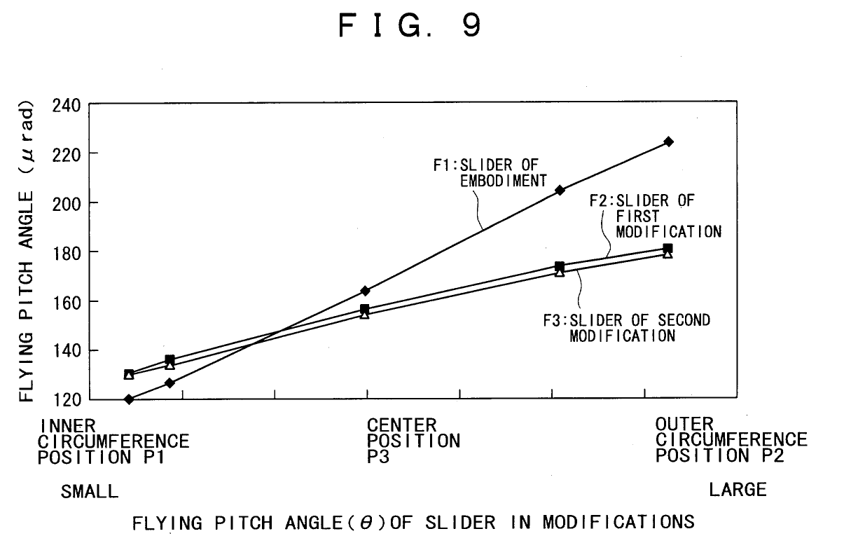

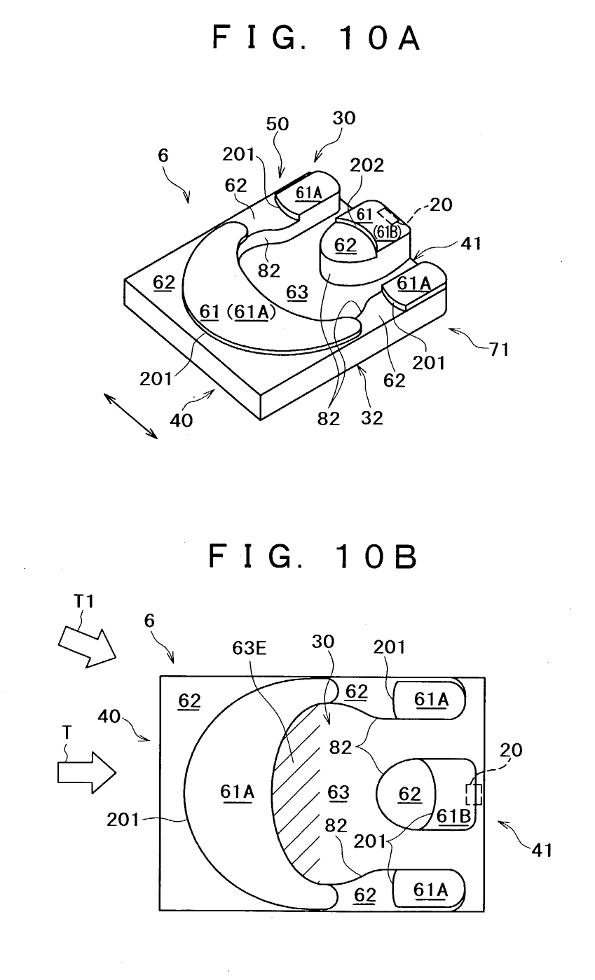

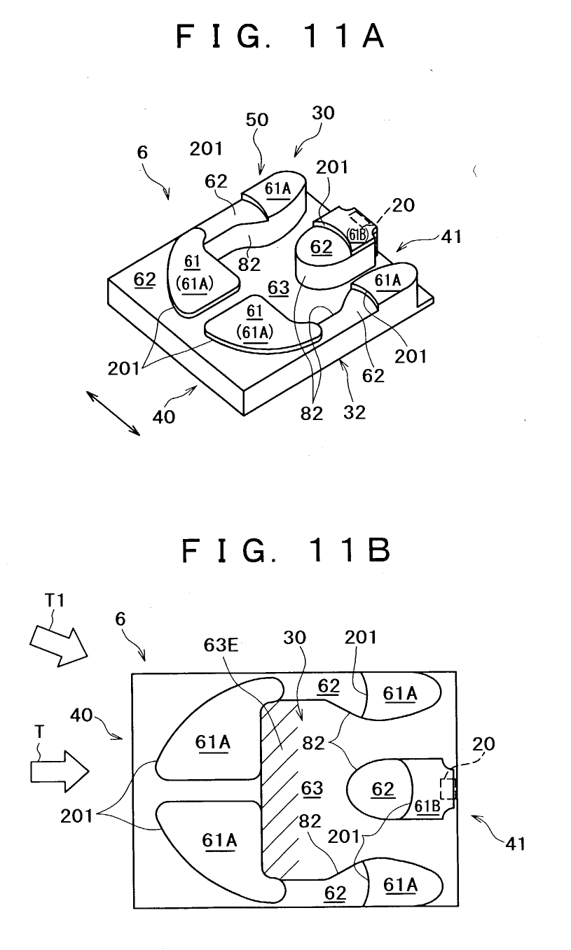

FIG. 9 illustrates an example of the variation of the flying pitch angle θ with regard to the slider of the embodiment shown in FIGS. 3 and 4 and modified sliders shown in FIGS. 10 and 11.

Referring to FIG. 9, a line Fl indicates the variation of the flying pitch angle θ of the slider 6 shown in FIGS. 3 and 4; another line F2 indicates the variation of the flying pitch angle θ of the slider 6 shown in FIGS. 10A and 10B; and a further line F3 indicates the variation of the flying pitch angle θ of the slider 6 shown in FIGS. 11A and 11B.

The axis of ordinate of FIG. 9 indicates the flying pitch angle θ. In the present invention, preferably the flying pitch angle θ ranges from 120 μrad to 240 μrad. The axis of abscissa indicates the range of the magnetic disk from the inner circumference position P1 to the outer circumference position P2 wherein the central position is denoted by P3.

As can be seen apparently from the lines F1, F2 and F3 of FIG. 9, the flying pitch angle θ in the embodiment of the present invention and the modifications thereto is at least equal to or greater than 120 μrad at the inner circumference position P1.

Now, different shapes of the slider of the present invention are described with reference to FIGS. 10A, 10B and 11A, 11B.

In the slider 6 of the first and second modifications shown in FIGS. 10A, 10B and 11A, 11B, portions corresponding to those of the slider shown in FIGS. 3 and 4 are denoted by like reference characters and overlapping description of them is omitted herein to avoid redundancy.

In FIGS. 3, 10B and 11B, air flowing in directions T and T1 are shown. The air flowing in direction T1 indicates an air flowing in direction where the slider 6 is mounted such that the center axis CL thereof is inclined up to an angle G against the center axis CL1 of the suspension 7 as seen in FIG. 6A. The air flowing in direction T is an air flowing in direction where the center axis CL of the slider 6 and the center axis CL1 of the suspension 7 are aligned to each other. Whichever of the air flowing in directions T and Ti is adopted, the slider 6 in any of the embodiment and the modifications flies.

The slider 6 of the modification of FIGS. 10A and 10B is different in the following points from the slider 6 of the embodiment shown in FIGS. 3 and 4.

In particular, the first air bearing surface 61 has a positive pressure generation surface 61A adjacent to the air flowing in end 40, two positive pressure generation surfaces 61A adjacent to the air flowing out end 41, and a single positive pressure generation surface 61B adjacent to the air flowing out end 41. The positive pressure generation surface 61A adjacent to the air flowing in end 40 has, for example, a substantially sectoral shape and is formed substantially over the entire width of the slider 6 in the Y direction.

The second air bearing surface 62 is formed such that the depth thereof increases toward the front surface portion 32 through first offset portions 201 with respect to the positive pressure generation surfaces 61A or the positive pressure generation surface 61B of the first air bearing surface 61. The third air bearing surface 63 is formed with a further great depth through a second offset portion 82. The third air bearing surface 63 has a negative pressure generation portion 63E.

The slider 6 shown in FIGS. 11A and 11B is a modification to but is different from the slider 6 of the modification of FIGS. 1A and 10B only in that the positive pressure generation surface 61A of the first air bearing surface 61 adjacent to the air flowing in end 40 is divided into two left and right portions. Description of the other common components of the slider 6 of the modification of FIGS. 11A and 11B is omitted herein to avoid redundancy.

The flying head slider described above is applied to the hard disk drive apparatus 10 shown in FIG. 1.

The hard disk drive apparatus 10 is called fixed hard disk drive apparatus and does not allow removal of the magnetic disk 2.

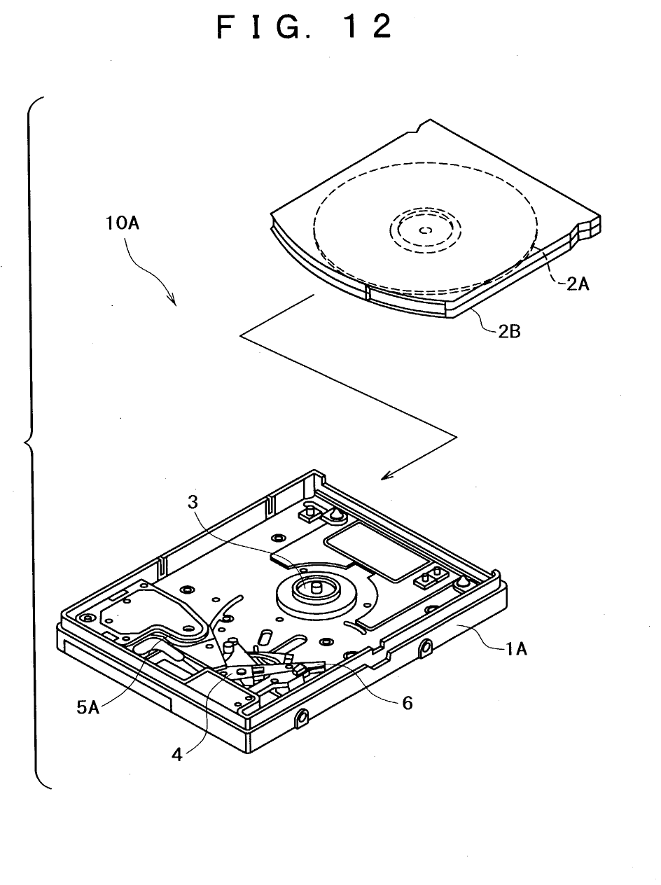

On the other hand, FIG. 12 shows a removable hard disk drive apparatus 10A. Referring to FIG. 12, the removable hard disk drive apparatus 10A shown includes a spindle motor 3, an arm 4 and a voice coil motor 5A accommodated in a housing 1A.

A magnetic disk 2A, which may be a hard disk, is accommodated in a case 2B. The case 2B can be removably mounted in the housing 1A.

The magnetic disk 2A mounted in the housing 1A can be continuously rotated by the spindle motor 3. The arm 4, slider 6 and voice coil motor 5A have a similar structure to that shown in FIG. 1, and overlapping description of the structure is omitted herein to redundancy.

The removable hard disk drive apparatus 10A is built or mounted particularly in an electronic apparatus of a small size such as, for example, a laptop personal computer or a PDA (Personal Digital Assistant; personal information terminal) The case 2B of the magnetic disk 2A is advantageous in that it can be removably and exchangeably mounted in the housing 1A.

The flying head slider described above can be applied also to the removable hard disk drive apparatus 10A having the configuration described above.

The information recording and/or reproduction apparatus which includes the flying head slider of the present invention is not limited to a hard disk drive apparatus but includes an information recording and/or reproduction apparatus which records and reproduces information onto and from a magneto-optical disk (MO) which includes a mini disk (MD).

Further, the flying head slider of the present invention may carry a head for recording and reproducing an optical recording and reproduction disk. The information recording and/or reproduction apparatus, which incorporates the flying head slider, is also called optical recording and reproduction disk apparatus. The head of the slider includes, for example, an objective lens for illuminating light upon the disk and passing returning light from the disk therethrough and other necessary elements.

With any of the flying head sliders of the embodiment and the modifications described above, by setting the flying pitch angle θ of the slider equal to or greater than 120 μrad, even if the slider flies low, the contacting force of the slider with the surface 11 of the magnetic disk 2 is reduced even where the slider is incorporated in a near-contact system wherein the slider and the disk contact frequently to each other. From this reason, the advantage that, even if the slider is in a near contact state, the slider flies stably can be achieved.

Further, even in an environment wherein much dust is present in the proximity of the slider and the surface 11 of the magnetic disk, where the flying pitch angle θ of the slider is equal to or greater than 120 μrad, since the floating amount exhibits a little variation, the slider can fly stably even where the hard disk drive apparatus in which the slider is incorporated is, for example, a removable hard disk drive apparatus which allows movable mounting of a magnetic disk therein.

The information recording and/or reproduction apparatus of the embodiment and modifications of the present invention can be used as a large capacity storage apparatus, for example, for an information processing apparatus. The recording medium is a recording medium of the rotary disk type such as a magnetic disk, an optical disk or a magneto-optical disk. The slider can fly stably within the flying radius range of the disk even where the slider is applied to a near-contact system wherein the slider and the surface of the slider contact frequently to each other.

Preferably, the minimum value of the minimum levitation amount minFH within the flying radius range of the slider is equal to or less than 17 nm. If the minimum value minFH is greater than 17 nm, then the performance of the head when it records information onto the recording medium or reproduces information from the recording medium is deteriorated by the spacing loss.

In the sliders described above, the air bearing portion 50 has a three-layer structure wherein it has first to third air bearing surfaces. However, the air bearing portion 50 may otherwise include a fourth air bearing surface or more. In other words, the air bearing portion 50 may have a structure wherein it has three bearing surfaces of different layers or another structure wherein it has four or more air bearing surfaces of different layers.

While a preferred embodiment of the present invention has been described using specific terms, such description is for illustrative purposes only, and it is to be understood that changes and variations may be made without departing from the spirit or scope of the following claims.

What is claimed is:

1. A flying head slider having a head for recording and reproducing information onto and from a recording medium, said flying head slider having an air bearing portion at an opposing portion thereof which opposes to the recording medium, said flying head slider being acted upon by buoyancy by air bearing caused by dynamic pressure between said air bearing portion and a surface of the recording medium, said flying head slider being disposed with respect to the recording medium such that, within a flying region of said flying head slider in a radial direction of the information recording medium between an inner circumference position and an outer circumference position of the surface of the recording medium, a flying pitch angle equal to or greater than 120 μrad is formed between said air bearing portion and the surface of the recording medium.

2. A flying head slider according to claim 1, wherein the minimum value of the minimum floating amount when an air flowing out end of said air bearing portion flies above the surface of the recording medium is 17 nm or less.

3. A flying head slider according to claim 1, wherein the flying pitch angle ranges from 120 μrad to 240 μrad both inclusive.

4. A flying head slider according to claim 2, wherein said air bearing portion has:
a first air bearing surface formed adjacent to said opposing portion for generating positive pressure;
a second air bearing surface formed at a position deeper than said first air bearing surface; and
a third air bearing surface formed at a position deeper than said second air bearing surface; and
said first air bearing surface includes an air flowing in end side positive pressure generation surface formed adjacent to an air flowing in end of said air bearing portion with a full width in a widthwise direction of said flying head slider and an air flowing out end side positive pressure generation surface formed adjacent to the air flowing out end of said air baring portion and including said head.

5. An information recording and/or reproduction apparatus, comprising:
a head for recording and reproducing information onto and from a recording medium; and
a flying head slider carrying said head thereon, said flying head slider having an air bearing portion at an opposing portion thereof which opposes to the recording medium, said flying head slider being acted upon by buoyancy by air bearing caused by dynamic pressure between said air bearing portion and a surface of the recording medium,
said flying head slider being disposed with respect to the recording medium such that, within a flying region of said flying head slider in a radial direction of the information recording medium between an inner circumference position and an outer circumference position of the surface of the recording medium, a flying pitch angle equal to or greater than 120 μrad is formed between said air bearing portion and the surface of the recording medium.

6. An information recording and/or reproduction apparatus according to claim 5, wherein the minimum value of the minimum floating amount when an air flowing out end of said air bearing portion flies above the surface of the recording medium is 17 nm or less.

7. An information recording and/or reproduction apparatus according to claim 5, wherein the flying pitch angle ranges from 120 μrad to 240 μrad both inclusive.

8. An information recording and/or reproduction apparatus according to claim 6, wherein said air bearing portion has:
a first air bearing surface formed adjacent to said opposing portion for generating positive pressure;
a second air bearing surface formed at a position deeper than said first air bearing surface; and
a third air bearing surface formed at a position deeper than said second air bearing surface; and
said first air bearing surface includes an air flowing in end side positive pressure generation surface formed adjacent to an air flowing in end of said air bearing portion with a full width in a widthwise direction of said flying head slider and an air flowing out end side positive pressure generation surface formed adjacent to the air flowing out end of said air baring portion and including said head.

9. An information recording and/or reproduction apparatus according to claim 5, wherein the recording medium is a removable disk.
